(19) United States
(12) Patent Application Publication
(10) Pub. No.: US 2006/0266915 A1
(43) Pub. Date: Nov. 30, 2006

(54) Tray mold

(75) Inventor: Robert John Parker, Winchester, VA (US)

Correspondence Address: FLESHNER & KIM, LLP, P.O. BOX 221200, CHANTILLY, VA, 20153, US

(73) Assignee: Ice Cube, Inc.

(21) Appl. No.: 11/439,165

(22) Filed: May 24, 2006

Related U.S. Application Data
(60) Provisional application No. 60/683,802, filed on May 24, 2005.

(51) Int. Cl. A23G 9/00

(52) U.S. Cl. 249/66.1

(57) ABSTRACT

A tray mold is provided. The tray mold comprises a base tray, a plurality of compartments formed in the base tray, and one or more mold portions formed in each of the plurality of compartments. The tray mold further comprises a top tray insert configured to be coupled to the base tray, a plurality of compartments formed in the top tray insert, and one or more mold portions formed in each of the plurality of compartments, wherein the one or more mold portions formed in each of the plurality of compartments complement the one or more mold portions of the base tray.

The present application claims priority to U.S. Provisional application No. 60/683,802 filed May 24, 2005, which is hereby incorporated by reference.

### BACKGROUND OF THE INVENTION

1. Field of the Invention

The invention is directed to a tray mold. More particularly, the invention is directed to a tray mold capable of molding, for example, ice cubes, candies, and food stuffs into two- and three-dimensional representations.

2. Background of the Related Art

There are commercially available ice trays that produce two- and three-dimensional novelty ice cube items, such as golf balls, footballs, football helmets, and other similar novelty items. However, these ice trays are limited to producing ice cubes and do not have the capability of readily producing acceptable items in other materials.

Further, currently available ice trays are limited in their ability to reproduce accurate and precise representations. Typically, ice cubes produced from these trays exhibit excess material around the “part line” or juncture of the halves. This presents a ragged and esthetically objectionable appearance that often renders the ice cube product unrecognizable.

### SUMMARY OF THE INVENTION

An object of the invention is to solve at least the above problems and/or disadvantages and to provide at least the advantages described hereinafter.

The invention is directed to a tray mold. More particularly, the invention is directed to a tray mold capable of molding, for example, ice cubes, candies, and food stuffs into two- and three-dimensional representations.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to like elements wherein:

FIG. 1 is a top view of a tray mold according to an embodiment of the invention;

FIG. 2 is a sectional view of the tray mold of FIG. 1 taken along line 2A-2A in FIG. 1;

FIG. 3 is a top view of a tray mold according to another embodiment of the invention;

FIG. 4 is a sectional view of the tray mold of FIG. 3 taken along line 4A-4A in FIG. 3;

FIG. 5 is a side view of the tray mold of FIG. 3;

FIG. 6 is an end view of the tray mold of FIG. 3;

FIG. 7 is a sectional view of the tray mold of FIG. 3 taken along line 7A-7A in FIG. 3.

FIG. 8 is a sectional view of the tray mold of FIG. 3 taken along line 8A-8A in FIG. 3;

FIG. 9 is a top view of a base tray of a tray mold according to another embodiment of the invention;

FIG. 10 is a left-side view of the base tray of FIG. 9;

FIG. 11 is a top view of a top tray insert of a tray mold according to an embodiment of the invention,

FIG. 12 is a right-side view of the top tray insert of FIG. 11;

FIG. 13 is a sectional view of the base tray of FIG. 9 taken along line 13A-13A in FIG. 9 and the top tray insert of FIG. 11 taken along line 13B-13B in FIG. 11, showing the tray mold together with the latch closed;

FIG. 14 is an enlarged view of area 14A in FIG. 13;

FIG. 15 is a sectional view of the base tray of FIG. 9 taken along line 13A-13A in FIG. 9 and the top tray insert of FIG. 11 taken along line 13B-13B in FIG. 11, showing the tray mold together, but with the latch open;

FIG. 16 is a sectional view of the base tray of FIG. 9 taken along line 13A-13A in FIG. 9 and the top tray insert of FIG. 11 taken along line 13A-13B in FIG. 11;

FIG. 17 is a top view of an example of a compartment of a top tray insert, such as that shown in FIG. 11; and

FIGS. 18A-18E are examples in which embodiments of the invention are configured to mold logos or seals of the various branches of the U.S. military.

### DETAILED DESCRIPTION OF PREFERRED EMBODIMENTS

The present invention is directed to a tray mold. The tray mold according to embodiments of the invention can be used to mold, for example, ice cubes, candies, and other food stuff. The tray mold according to one embodiment of the invention is capable of molding a two-dimensional representation of an object with precision. Further, the tray mold according to embodiments of the invention is configured to prevent nesting between multiple tray molds. Additionally, the tray mold according to another embodiment of the invention is capable of molding a full three-dimensional representation of an object with precision, as opposed to partial or two-dimensional representations provided by conventional tray molds. Furthermore, the tray mold according to embodiments of the invention may be compartmentalized, allowing one to produce, for example, ice cubes, candies, and other food stuffs, from different materials in one tray mold simultaneously and/or store such products as desired. In the present application, the drawings are directed to molding a two-dimensional or full three-dimensional representation of a hand grenade; however, one of ordinary skill in the art will recognize that embodiments of the invention may be utilized to mold, for example, ice cubes, candies, and other food stuffs into any shape, size, design, and/or two- or three-dimensional representation of an object.

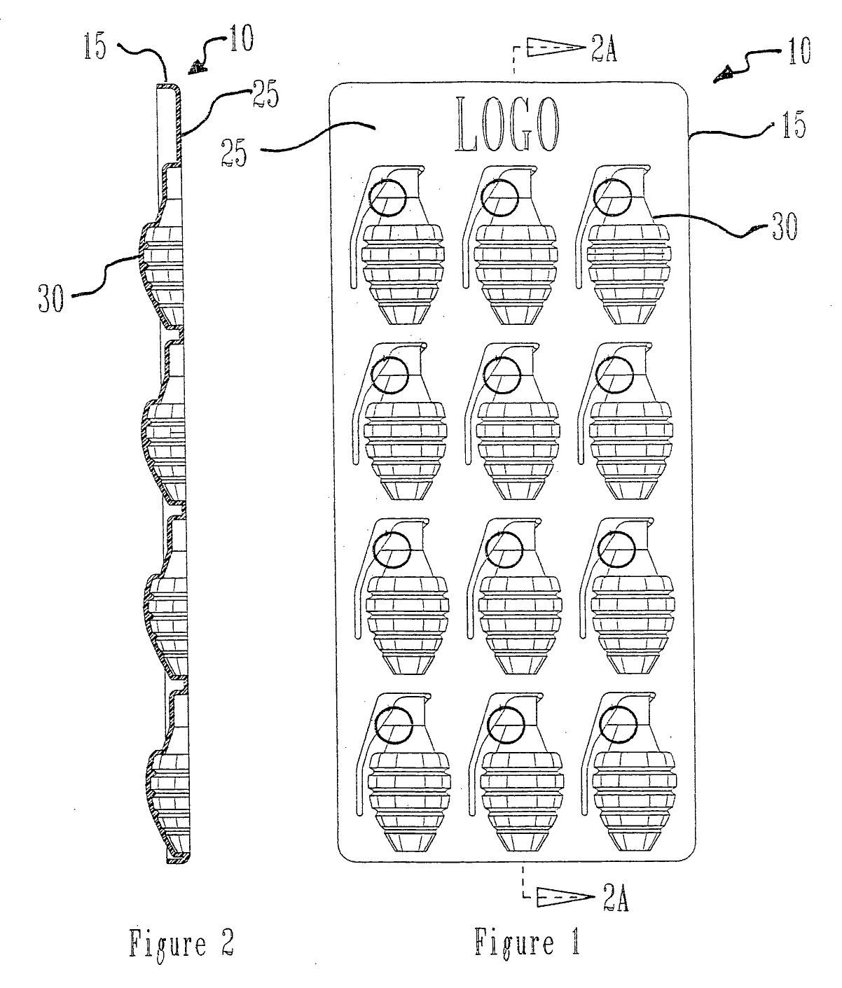

FIG. 1 is a top view of a tray mold according to an embodiment of the invention, while FIG. 2 is a sectional view of the tray mold of FIG. 1 taken along line 2A-2A in FIG. 1. The tray mold 10 includes a base tray 15 in which one or more mold portions 30 are formed. The base tray 15 may include an area 25 for a company logo or other design or text. The tray mold 10 may be formed out of polypropylene or other similar materials capable of withstanding a wide range of temperatures, and that are flexible and washable. The tray mold according to this embodiment is capable of molding a two-dimensional representation of an object with precision, in this embodiment shown as a partial, half or two-dimensional representation of a hand grenade.

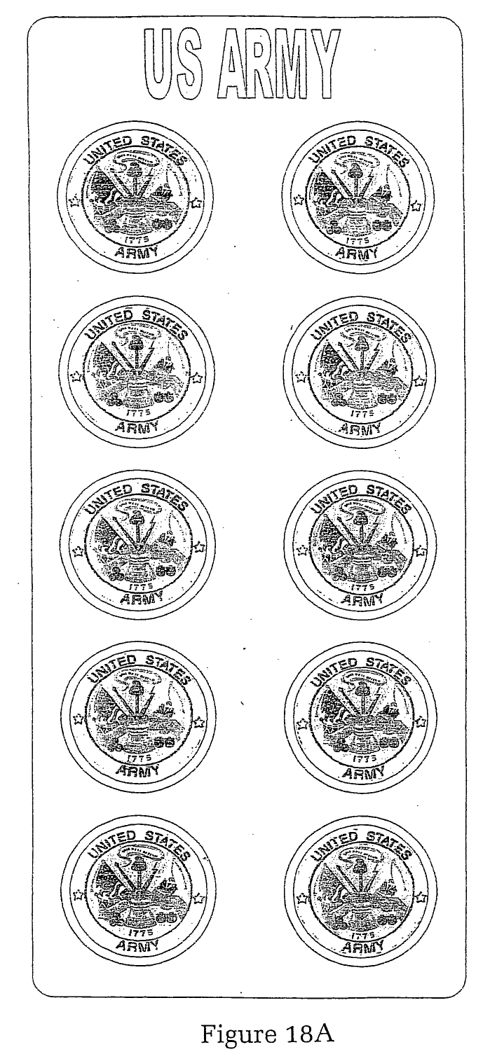

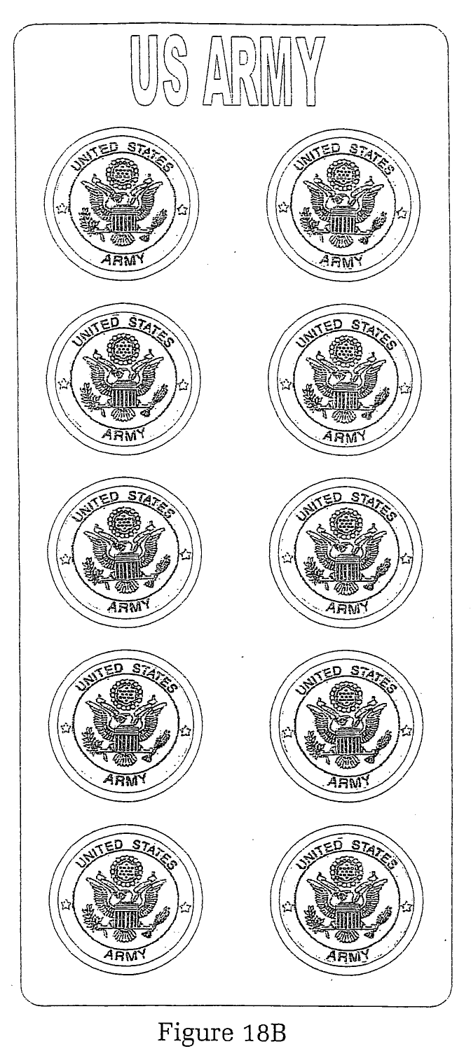

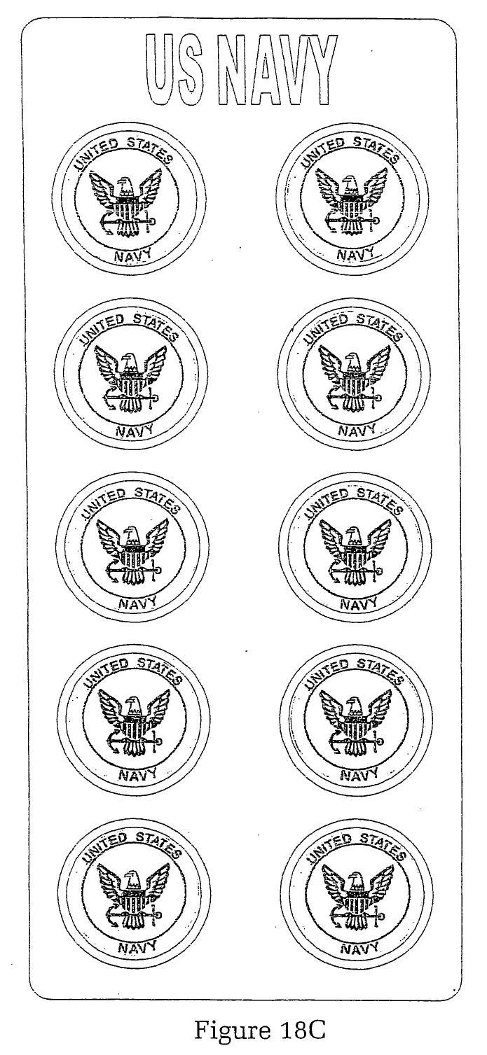

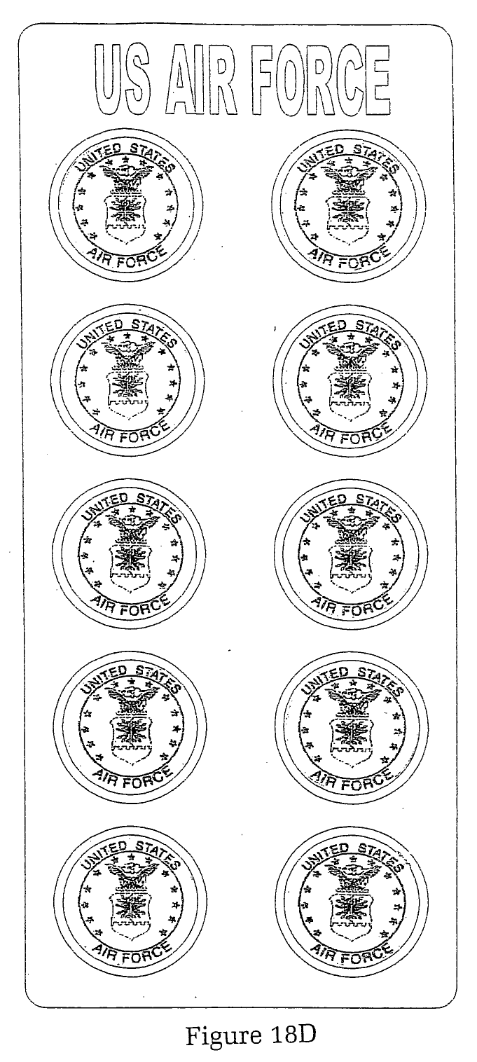

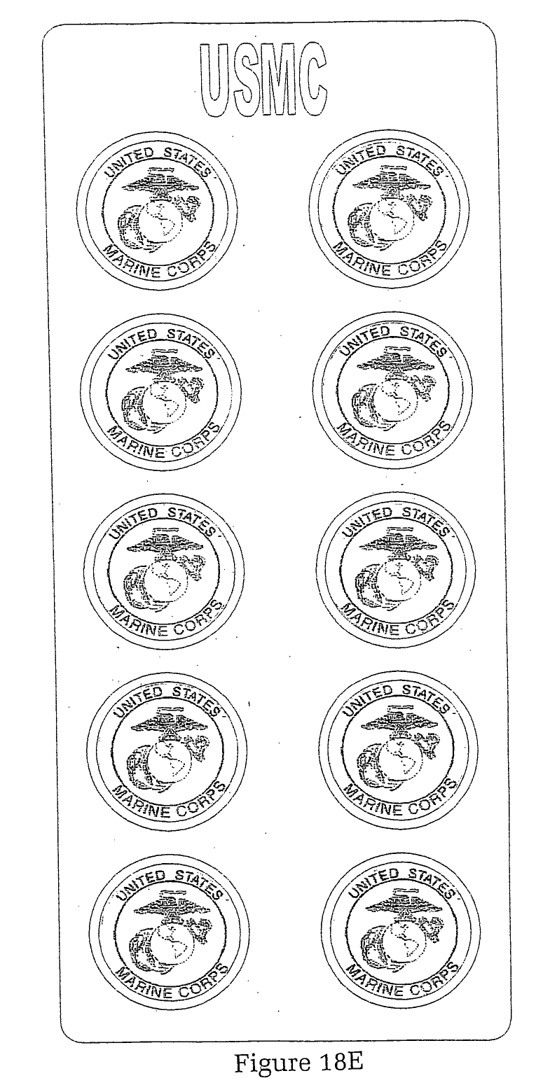

As set forth above, in the embodiment of FIGS. 1-2, the two-dimensional representation is shown as a partial or half representation of a hand grenade. However, as further indicated above, embodiments of the invention may be utilized to mold, for example, ice cubes, candies, and other food stuffs into any shape, size, design, and/or two- or three-dimensional representation of an object. For example, embodiments of the invention may be utilized to mold logos, seals, or emblems into, for example, ice cubes, candies, and other food stuffs. For example, as shown in FIGS. 18A-18E, embodiments of the invention may be utilized to mold logos, seals, or emblems of branches of the U.S. military, including the U.S. Navy, U.S. Marine Corps, U.S. Army, U.S. Air Force, and U.S. Coast Guard into, for example, ice cubes, candies, and other food stuffs to create two- or three-dimensional representations, such as an ice cube with logos, seals, or emblems on one or more sides of the ice cube. In such a case, the area 25 (FIG. 1), 125 (FIG. 3 discussed below) of the tray mold may be used to print a logo, company name, military branch name, or other text, as shown in FIGS. 18A-18E.

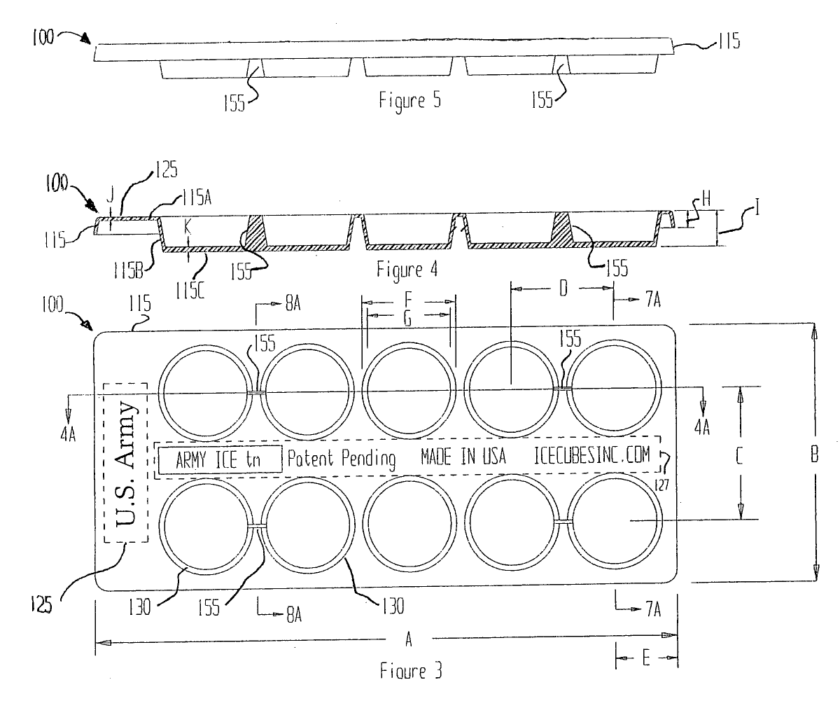

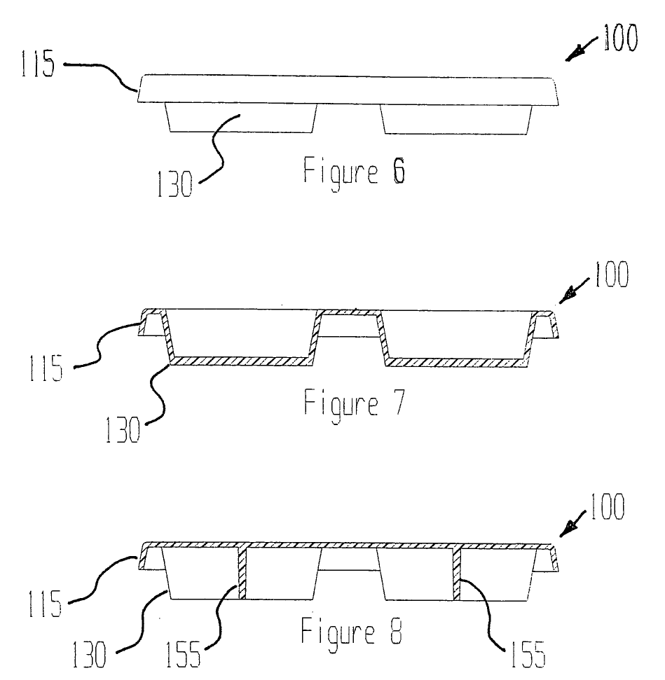

In such an embodiment, a tray mold may be configured to include, for example, ten emblem molds as shown in FIG. 3. That is, FIG. 3 is a top view of a tray mold according to another embodiment of the invention. FIG. 4 is a sectional view of the tray mold of FIG. 3 taken along line 4A-4A in FIG. 3. FIG. 5 is a side view of the tray mold of FIG. 3. FIG. 6 is an end view of the tray mold of FIG. 3. FIG. 7 is a sectional view of the tray mold of FIG. 3 taken along line 7A-7A in FIG. 3, and FIG. 8 is a sectional view of the tray mold of FIG. 3 taken along a line 8A-8A in FIG. 3.

The tray mold 100 shown in FIGS. 3-8 includes a base tray 115, having a plurality of mold portions 130 formed therein. In the embodiment of FIGS. 3-8, a logo, company name, military branch name, or other text may be imprinted in the area 125, as shown in FIGS. 3 and 18A-18E. Further, a logo, company name, military branch symbol/name, or other text may be imprinted in an area 127 between mold portions 130, as shown in FIG. 3. The tray mold 100 may be formed out of polypropylene or other similar materials.

Additionally, reinforcing bars 155 may be provided between mold portions 130. The reinforcing bars 155 function to reinforce the tray mold 100 as well as assist in the removal of the molded product from the tray mold 100. The reinforcing bars 155 additionally aid in stacking the multiple tray molds 100 by preventing nesting of the tray molds 100.

In one embodiment, the top and side walls 115A, 115B of the tray mold 100 have a thickness J less than a thickness K of the bottom wall 115C of the mold portions 130 (see FIG. 4). This increased thickness in the bottom wall 115C of the mold portions 130 provide a more precise representation by slowing the freezing process adjacent the bottom wall 115C.

For example, referring to FIGS. 3 and 4, for a tray mold having the following dimensions:
A≈11.25 inch
B≈4.874 inch
C≈2.500 inch
D≈1.9800 inch
E≈1.185 inch
F≈1.730 inch
G≈1.540 inch
H≈0.325 inch
I≈0.675 inch
   the thickness J would preferably be ˜0.060 inch and the thickness K would preferably be ≈0.098 inch.

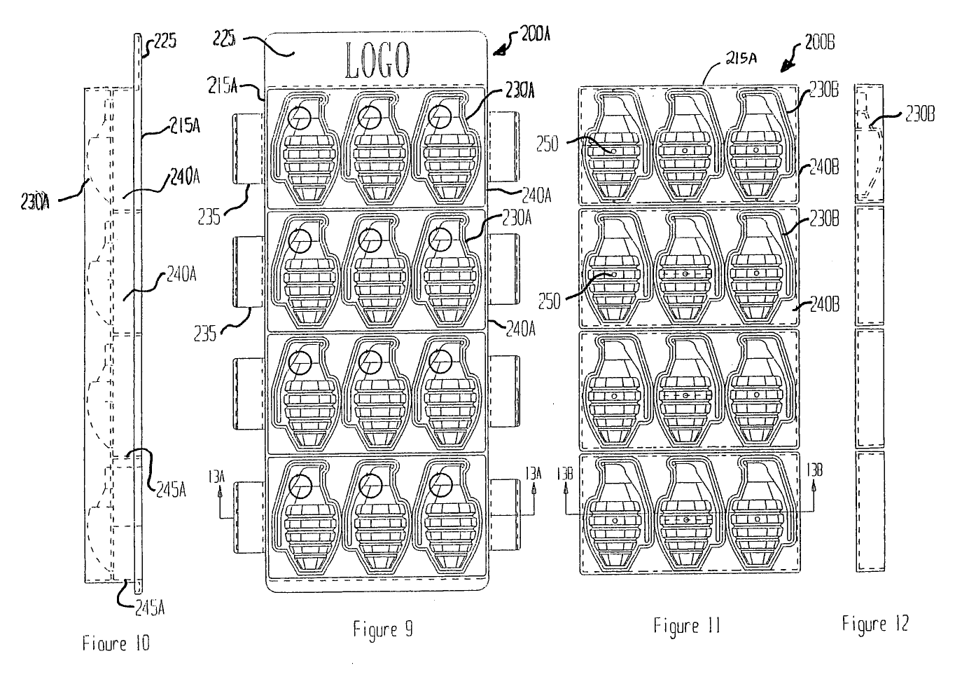

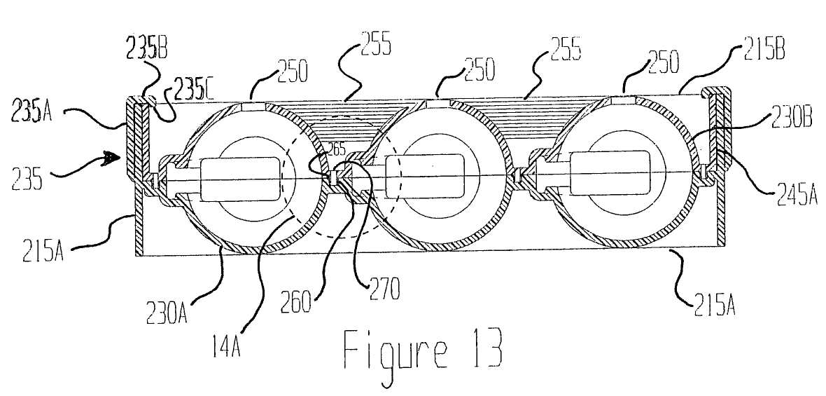

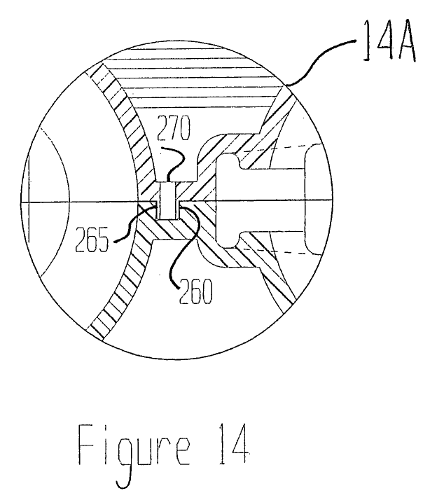

FIG. 9 is a top view of a base tray of a tray mold according to an embodiment of the invention. FIG. 10 is a left-side view of the base tray of FIG. 9. FIG. 11 is a top view of a top tray insert of a tray mold according to an embodiment of the invention. FIG. 12 is a right-side view of the top tray insert of FIG. 11.

As shown in FIGS. 9-12, a tray mold according to one embodiment of the invention includes a base tray 200A, as shown in FIGS. 9-10, and a top tray insert 200B, as shown in FIGS. 11-12. As will be discussed in more detail below, the base tray 200A and top tray insert 200B are configured to be coupled together to create a mold for molding, for example, ice cubes, candies, and other food stuffs, into a three-dimensional representation of an object, in this embodiment, a hand grenade. That is, the top tray insert 200B is configured to be coupled to the base tray 200A. Further, once coupled the base tray 200A and top tray insert 200B may be locked together.

The base tray 200A includes a base member 215A in which a plurality of compartments 240A are formed. In each compartment 240A, one or more mold portions 230A are formed. Each mold portion 230A provides a portion, for example, one half of a three-dimensional representation of an object, in this embodiment a hand grenade, and is provided in only a portion of the compartment 240A, such that a portion 245A of the compartment remains open. As will be further discussed below, the open portions 245A of the compartments 240A are configured to receive a complementary mold portion 230B to form the three-dimensional representation as the top tray insert 200B is coupled to the base tray 200A.

The top tray insert 200B also includes a plurality of compartments 240B. In each compartment, one or more complementary mold portions 230B are formed in complement to the one or more mold portions 230A formed in each compartment 240A of the base tray 200A. The base tray 200A and top tray insert 200B may both be formed out of polypropylene or other similar materials. The desired contour of the top tray insert mating surface may be, for example, ˜0.010 to 0.015 inch convex.

The coupling capability of the tray mold 200A, 200B allows products, such as, for example, ice cubes, candies, and other food stuffs to be molded with precision. Further, the tray mold 200A, 200B creates a clean, air-tight environment configured to protect molded products, from, for example, spillage or damage until needed. The optional locking capabilities of the tray mold 200A, ?OOB discussed further below provide added protection.

Furthermore, the plurality of compartments 240A, 240B provided in the base tray 200A and top tray insert 200B limit and effectively control the distortion characteristics inherent in thermoplastic molding materials. Additionally, the plurality of compartments 240A, 240B permit the selective removal and use of products, such as, for example, ice cubes, candies, and other food stuffs, molded by the tray mold 200A, 200B. That is, unused products may be left in the tray mold in a clean, air-tight, protected environment. Also, the plurality of compartments 240A, 240B allow multiple products to be made out of different materials in the same tray mold. For example, ice cubes, candies, chocolates, sherbets, and/or butter may be molded simultaneously in the same tray mold.

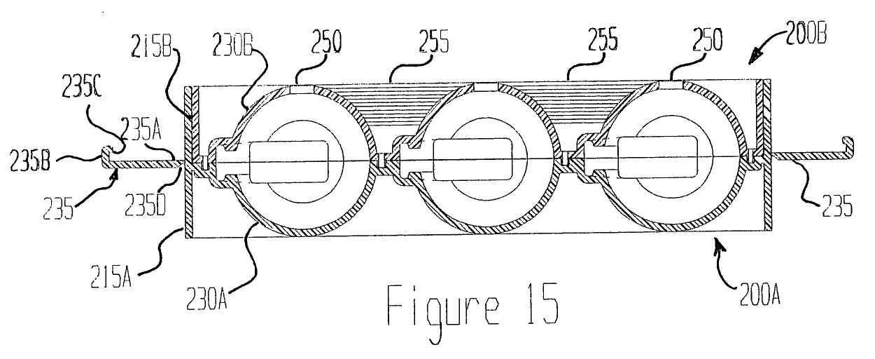

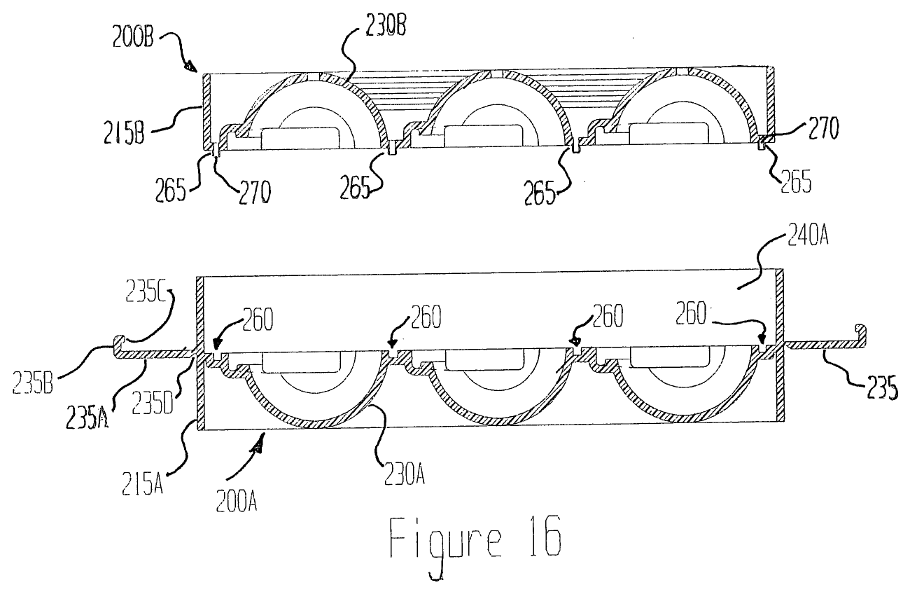

The base tray 200A may include one or more latches 235 which are used to lock the top tray insert 200B to the base tray 200A. The latches 235 may be integrally molded with the base tray 200A. As shown in FIGS. 15 and 16, the latch 235 may include a first portion 235A hingedly connected to the base member 215A by a hinge portion 235D, a second portion 235B, which extends at a right angle to the first portion 235A, and a third portion in the form of a lip 235C. The latch 235 functions to lock the top tray insert 200B to the base tray 200A, as shown in FIG. 13. In this embodiment, a pair of latches 235 is provided for each pair of complementary compartments 240A, 240B. The latches 235 when fastened pull the top tray insert 200B into full contact with the tray base 200A, matching up pairs of complementary compartments 240A, 240B and molds 230A, 230B. If provided for each complementary pair of compartments 240A, 240B, the latches 235 provide secure retention and mating of the base tray 200A and top tray insert 200B. This ensures the three-dimensional molds produced are precise representations. Of course, the latches could also be formed on the top tray insert 200B, in which case they would latch to portions of the base tray 200A.

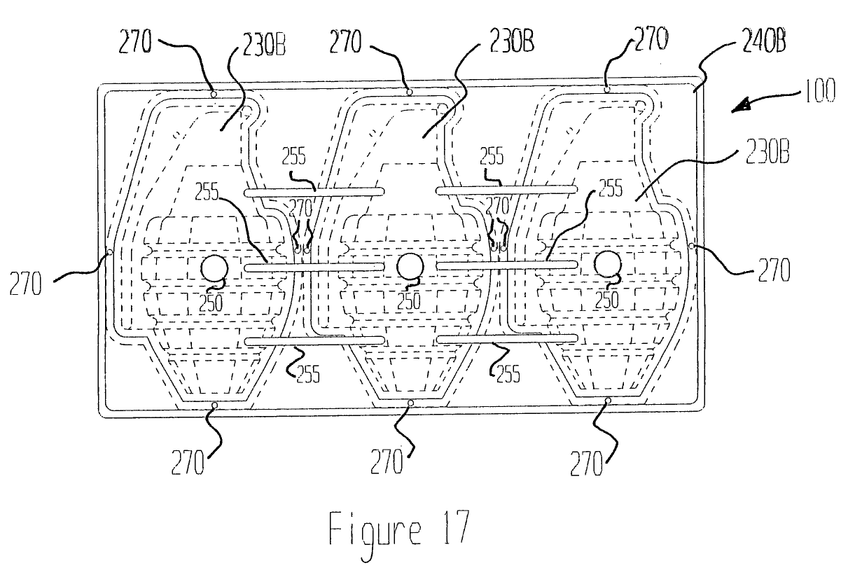

Additionally, the base tray 200A may include one or more grooves 260 configured to mate with one or more protrusions 265 provided on the top tray insert 200B, as shown in FIGS. 13-16. The top tray insert 200B may further include a vent hole 270 corresponding to each protrusion 265, which may function, for example, to vent excess material. The mating protrusions 265 and grooves 260 may be provided surrounding each mold 230A, 230B to ensure an accurate molding, free of excess material and flash at the parting line, each with a vent 270 as shown in FIG. 17. Alternatively, the grooves 260 may be formed on the top trav insert 200B and the protrusions 265 formed on the base tray 200A. Further, the protrusions 265 may comprise tapered sides and radiuses to facilitate ease of assembly and ensure precise alignment of mold portions 230A, 230B for each use.

The top tray insert 200B may also include one or more warpage control bars 255 provided in between mold portions 230B, as shown in FIG. 17. The one or more warpage control bars 255 function to reinforce the top tray insert 200B and may also function as a handle when insetting and removing the top tray insert 200B into the base tray 200A. Additionally, the warpage control bars 255 may function to substantially prevent the formation of a concave surface for the top tray insert 200B. That is, the top tray insert 200B part line is caused to be slightly convex by the warpage control bars. The top tray insert 200B is then pulled flat when latched to the base tray 200A by latches 235. This effectively controls the distortion characteristic inherent in thermoplastic molding and aids in the production of an aesthetically pleasing molded representation. The warpage control bars may be configured in various number bar combinations to predictably control the warpage of the top tray insert.

Further, as shown in FIGS. 11, 13, and 15-17, the top tray insert 200B may include one or more vent/fill holes 250 provided to vent overflow water in the case of molding, for example, ice cubes, or as a fill hole in the case of molding, for example, candy, chocolates, gelatin, or other food stuffs.

As set forth above, these embodiments of the invention are shown as configured to mold a three-dimensional representation of a hand grenade. However, one of ordinary skill in the art will recognize that embodiments of the invention may be utilized to mold, for example, ice cubes, candies, and other food stuffs into any shape, size, design, and/or two- or three-dimensional representation of an object.

In use, the top tray insert 200B is inserted into the base tray 200A. Latches 235, which in the embodiment of FIGS. 9-17 are provided for each complementary pair of compartments 240A, 240B, may then be fastened to lock the top tray insert 200B to base tray 200A

For ice cubes, the tray base 200B may be first filled with water and the top tray insert 200B then pressed down into the base tray 200A. Excess water may then be evacuated through vent/fill holes 250 and vents 270. The water retained in the three-dimensional mold formed by mold portions 230A, 230B can then be frozen. Because the water will expand upon freezing, the ice will extend into the space in the mold portions 230B in the top tray insert 200B. This procedure ensures a 100% complete and faithful reproduction in each cavity.

For candies and other suitable food stuffs, the top tray insert 200B may be inserted into the base tray 200A. The candies or other suitable foodstuffs may then be injected into the three-dimensional mold formed by mold portions 230A, 230B through the vent/fill holes 250 with, for example, a suitable food or pastry injector. After the three-dimensional mold formed by mold portions 230A, 230B are filled, the side latches 235 may be secured for each pair of complementary compartments 240A, 240B. Excess material may then be evacuated through the vent/fill holes 250 and vents 270. This procedure ensures a 100% complete and faithful reproduction in each cavity.

Embodiments of the invention have at least the following advantages.

Embodiments of the invention are capable of producing unique two- and three-dimensional, for example, ice cubes, candies, and other suitable food stuffs for use, for example, at parties, dinners, reunions, banquets, and special and commercial events.

Further, embodiments of the invention are capable of producing accurate, precise representations of, for example, unique, historic, military, and commercial products, and other items of special and significant interest.

Furthermore, embodiments of the invention represent significant improvements and departure from the currently available commercial tray products.

Additionally, as set forth above, embodiments of the invention provide a clean, air-tight, protected environment for molding with precision three-dimensional products, such as ice cubes, candies, and other suitable foodstuffs. The optional locking capabilities provide added protection.

Further, embodiments of the invention provide a compartmentalized tray that limits and effectively controls distortion characteristics inherent in thermoplastic molding materials. Further, the compartmentalized tray according to embodiments of the invention permits the selective removal and use of, for example, ice cubes, candies, and other suitable foodstuffs. Unused products may be stored in an optionally locked, clean, air-tight environment, protected from, for example, spillage or damage until needed.

Furthermore, the compartmentalized tray according to embodiments of the invention permits production of multiple three-dimensional products, such as ice cubes, candies, and other suitable foodstuffs in the same tray. For example, ice cubes, candies, chocolates, sherbets, and/or butter can be molded in the same tray simultaneously.

Also, the compartmentalized tray according to the invention permits ease of use for producing three-dimensional ice cubes. Additionally, the compartmentalized tray permits ease of use for producing three-dimensional candies and other suitable foodstuffs.

In addition, because each mold perimeter is surrounded by a continuous, precise protrusion and groove detail, an accurate part line registry for the mating base tray and top tray insert is provided. This system eliminates the esthetically objectionable mismatch normally encountered on commercially available tray molds.

Further, the top tray insert may contain multiple vent/fill holes that vent into the top tray insert interior. This vent system may be used to evacuate any residual liquids or materials that may enter the protrusion and groove detail during pouring or filling of the molds. The vent system may be used to efficiently evacuate liquids and other materials.

The foregoing embodiments and advantages are merely exemplary and are not to be construed as limiting the invention. The present teaching can be readily applied to other types of apparatuses. The description of the invention is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

What is claimed is:

1. A tray mold, comprising;
a base tray;
a plurality of compartments formed in the base tray; and
one or more first mold portions formed in each of the plurality of compartments.

2. The tray mold of claim 1, wherein the one or more mold portions comprise a logo, seal, or emblem.

3. The tray mold of claim 2, wherein the one or more mold portions comprises a seal of one branch of the U.S. military.

4. The tray mold of claim 1, wherein the base tray comprises an area on which text can be imprinted.

5. The tray mold of claim 4, wherein the text comprises a logo or company name.

6. The tray mold of claim 1, wherein the one or more mold portions comprise a plurality of mold portions and the tray mold further comprises one or more reinforcement bars configured to prevent nesting of multiple tray molds extending between two or more of the plurality of mold portions.

7. The tray mold of claim 1, wherein the one or more mold portions fills only a portion of the respective compartment.

8. The tray mold of claim 7, wherein the one or more mold portions fills only one half of the respective compartment.

9. The tray mold of claim 1, wherein each compartment includes a first portion containing the one or more mold portions and a second portion configured to receive a complementary mold portion formed in a top tray insert.

10. The tray mold of claim 1, wherein a thickness of top and sidewalls of the base tray is less than a thickness of a bottom wall of the one or more mold portions.

11. The tray mold of claim 1, further comprising:
a top tray insert configured to be coupled to the base tray;
a plurality of compartments formed in the top tray insert; and
one or more mold portions formed in each of the plurality of compartments of the top tray insert, wherein the one or more mold portions formed in each of the plurality of compartments complement the one or more mold portions of the base tray.

12. The tray mold of claim 11, further comprising one or more latches configured to latch the top tray insert to the base tray.

13. The tray mold of claim 12, wherein the one or more latches comprise a pair of latches provided for each complementary pair of compartments.

14. The tray mold of claim 12, wherein the one or more latches are integrally formed with the base tray.

15. The tray mold of claim 12, wherein the one or more latches each comprises:
a first portion attached to one of the base tray and the top tray insert by a hinge portion;
a second portion that extends substantially perpendicular to the first portion; and
a lip portion that extends from the second portion.

16. The tray mold of claim 11, wherein the one or more mold portions formed in the top tray insert comprise a plurality of mold portions connected by one or more warpage control bars.

17. The tray mold of claim 11, wherein the one or more mold portions formed in the top tray insert each comprise a vent/fill hole.

18. The tray mold of claim 11, wherein one of the top tray insert and the base tray comprises one or more protrusions configured to mate with one or more corresponding grooves provided on the other of the top tray insert and the base tray.

19. The tray mold of claim 18, wherein each of the one or more protrusions comprise a vent hole.

20. The tray mold of claim 18, wherein the one or more protrusions and one or more grooves comprise a plurality of mating protrusions and grooves.

21. The tray mold of claim 20, wherein a plurality of mating protrusions and grooves are provided around each pair of complementary mold portions.

22. The tray mold of claim 11, wherein the base tray and top tray insert are configured to be coupled together to create a substantially air-tight environment.

23. The tray mold of claim 1, wherein the tray mold is configured to mold ice cubes, candies, and other food stuffs.

24. The tray mold of claim 1, wherein the tray mold is formed of polypropylene.

25. A method of molding food stuffs, comprising:
coupling to a base tray having a plurality of individual compartments, each individual compartment having one or more mold portions formed therein, a top tray insert having a plurality of complementary compartments and mold portions; and
injecting food stuff into three-dimensional molds formed by the complementary mold portions via one or more vent/fill holes.

26. The method of claim 25, further comprising:
locking the top tray insert to the base tray prior to the injecting step.

27. A method of molding ice cubes, comprising:
filling a base tray with water, the base tray having a plurality of individual compartments, each individual compartment having one or more mold portions formed therein;
coupling to the base tray a top tray insert having a plurality of complementary compartments and mold portions; and
freezing the water to create molded ice cubes.

28. The method of claim 27, further comprising:
locking the top tray insert to the base tray prior to the freezing step.

29. The method of claim 27, further comprising:
evacuating any excess water from three-dimensional molds formed by the complementary mold portions via one or more vent/fill holes prior to the freezing step.
